(19) United States
(12) Patent Application Publication
(10) Pub. No.: US 2008/0004016 A1
(43) Pub. Date: Jan. 3, 2008

(54) WIRELESS COMMUNICATIONS SYSTEM USING SPATIALLY DISTRIBUTED SECTORS IN CONFINED ENVIRONMENTS

(75) Inventors: John Edward Smee, San Diego, CA (US); Sherman A. Gregory, San Diego, CA (US)

Correspondence Address: QUALCOMM INCORPORATED, 5775 MOREHOUSE DR., SAN DIEGO, CA, 92121, US

(73) Assignee: QUALCOMM, INCORPORATED, San Diego, CA (US)

(21) Appl. No.: 11/555,663

(22) Filed: Nov. 1, 2006

Related U.S. Application Data
(60) Provisional application No. 60/817,945, filed on Jun. 30, 2006.

(51) Int. Cl. H04Q 7/20

(52) U.S. Cl. 455/435.1

(57) ABSTRACT

A base station for establishing a picocell is configured so as to provide multiple sectors, with spatial diversity between sectors. The combination of the multiple sectors and the spatial diversity reduces signal power requirements in the air interface within a confined space and provides improvements in quality of service.

### CLAIM OF PRIORITY UNDER 35 U.S.C. §119

The present Application for Patent claims priority to Provisional Application No. 60/817,945 entitled “WIRELESS COMMUNICATIONS SYSTEM USING SPATIALLY DISTRIBUTED SECTORS IN CONFINED ENVIROMENTS” filed Jun. 30, 2006, and assigned to the assignee hereof and hereby expressly incorporated by reference herein.

### BACKGROUND OF THE INVENTION

1. Field of the Invention

This invention relates to wireless communications such as framed subscriber communications, and in particular, to a system that enables wireless subscriber stations to establish links within a vehicle consistent with terrestrial and non-terrestrial region communication links. The invention further relates to power reduction in vehicle based wireless communication systems.

2. Background

Wireless communication systems are widely deployed to provide various types of communication such as voice and data. A typical wireless data system, or network, provides multiple users access to one or more shared resources. A system may use a variety of multiple access techniques such as frequency division multiplexing (FDM), time division multiplexing (TDM), code division multiplexing (CDM), and others. Examples of wireless networks include cellular-based data systems. The following are several such examples: (1) the “TIA/EIA-95-B Mobile Station-Base Station Compatibility Standard for Dual-Mode Wideband Spread Spectrum Cellular System” (the IS-95 standard), (2) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (3) the standard offered by a consortium named “3rd Generation Partnership Project 2” (3GPP2) and embodied in “TR-45.5 Physical Layer Standard for cdma2000 Spread Spectrum Systems” (the IS-2000 standard), and (4) the high data rate (HDR) system that conforms to the TIA/EIA/1S-856 standard (the IS-856 standard).

In wireless communications, it is sometimes desired to establish a picocell with which to relay communications between a primary communications system and a local communications system. Typical primary communications systems include a terrestrial wireless subscriber communications network, a dedicated terrestrial communications network and a satellite communications network. An example of a local communications system is a base transmitter (BTS) establishing a picocell within an aircraft cabin or similar confined space. Typically, the base station for establishing a picocell provides wireless communication services as a replacement for a BTS communicating with remote stations or wireless communication devices (WCDs). One example of a communication system using a base station for establishing a picocell is found in US Patent Application No 2004-0142658, to Daniel McKenna, et al., and incorporated herein by reference. While a base transmitter (BTS) is described, the function can be that of a base station, Node B, or similar device performing the function of communicating with subscriber units or WCDs.

In a CDMA communications system, sectorization is typically implemented at a BTS by having the antennas for each sector point in different directions. A typical sectorized BTS may use 3 sectors, each covering 120 degrees around the BTS, with small overlap in antenna patterns. In a typical application, the antenna pattern overlap may be approximately 20%, so that well over 50% of the antenna coverage will be non-overlapping. This typical non-overlapping sector pattern is performed because of the need for spectral efficiency and to maximize the number of users per bandwidth. This arrangement is well-suited for typical urban and rural environments. Wireless communication within some moving vehicles, such as aircraft presents unique issues in that direct communication links with terrestrial base stations are less than optimal.

Repeaters are used in wireless communication systems in order to extend the range and coverage of the communication system. In general, repeaters receive and retransmit signals at the physical layer, and are able to provide satisfactory operation regardless of the standard being used by the wireless communication system. Repeaters are less than optimum, particularly in cases where a host base station cannot be easily defined by the repeater or it is desired that retransmissions within the vehicle be limited. In such cases, it is desired to establish a local station within the vehicle. Communication between the local station and the outside world can be accomplished by various techniques, such as those described in U.S. Patent Publication No. US2004/0142658, titled, “System for Integrating an Airborne Wireless Cellular Network with Terrestrial Wireless Cellular Networks and the Public Switched Telephone Network”, to Daniel Bernard McKenna. That publication is incorporated herein by reference.

Another aspect of communications within aircraft and similar vehicles is the fact that it is desired to provide proxy link transparency, by which the user's equipment is able to communicate according to terrestrial communication protocols. This requires a mirroring of terrestrial base station attributes so as to enable a localized cell for in-cabin communication yet retain the same wireless subscriber device attributes for the air-to-ground link. The air-to-ground network transmits both the subscriber data between the aircraft in-cabin network and the terrestrial network to thereby enable the users' wireless subscriber devices that are located in the aircraft to establish links consistent with terrestrial networks. In doing so, it is desired to establish communication with wireless subscriber devices independent the terrestrial environment.

In some cases, there is a requirement of minimizing the amount of RF energy transmitted, for example due to potential susceptibility of airplane electrical systems. In the aircraft environment, the potential of interference with aircraft nav/comm. equipment is a concern when providing active RF radiators, such as WCDs. While there are no known interference issues, at least with installed avionics, the use of a large number of WCDs within the cabin is of concern. Nevertheless, there remains a concern that excessive signal transmissions could conceivably interfere with navigation systems under particular circumstances. By way of example, airlines had forbidden passengers from using cellular telephones while an aircraft was taxiing to a terminal even though no navigation instruments are used during taxi.

Typically, CDMA cellular communications use multiple sectors for each base station. The communication sectors use different pseudorandom codes, so that communication with one WCD is effected through a pseudorandom code applied to one sector. The base station provides a soft or softer handoff between sectors for a given WCD. The sectors are designed for a minimum overlap, thereby reducing overall power and increasing the capacity of the base station in terms of number of WCDs that can be simultaneously served.

The minimum of overlap between the sectors optimizes capacity. A consequence of sector overlap is the lowering of the carrier-to-interference ratio (C/I) on the forward link for the best serving sector since the interference component will include the signal from the other transmitting sectors and since our technique results in more sectors being seen by a user this would limit the forward link data rate for systems such as 1×EV-DV and 1×EV-DO. If each sector has a large number of users in softer handoff, then the forward link capacity can reach a dimensionality limit due to the finite number (e.g., 64 or 128) of orthogonal Walsh codes.

### SUMMARY

According to the present invention, a base station establishing a picocell establishes an air interface in a shared channel communication system in at least two antenna patterns. The base station functions within a confined space for wireless communication, using first and second antennas having antenna patterns arranged so that the antenna patterns provide a significant pattern of overlap so as to provide significant spatial diversity. The antennas are configured to provide a significant coverage overlap between sectors, so that the overlap exceeds 50% of the coverage areas of the respective antennas in at least two of the sectors. If the sectors use different pseudorandom codes, the sectors can provide a soft or softer handoff between sectors for users communicating with the base station.

The antennas may be arranged such that at least two sectors have spatially separated antennas. In one configuration, the physical separation exceeds a certain proportion of an intended coverage area for the base station corresponding to said small space, for example, 10%, 5%, or 1% of an intended coverage area for the base station, although it is possible to have physical separation outside of these ranges if there is significant signal path diversity and overlap of sectors. This separation is combined with a significant overlap of sectors, for example at least a 50% overlap between at least two of the sectors. The antenna patterns of the first sector and the second sector can be arranged to provide spatial diversity of at least 1λ.

In a further aspect of the invention, a base station establishes an air interface in a shared channel communication system within a limited space for wireless communication. The base station includes at least two RF communication circuits, establishing multiple communication sectors. At least two of the sectors provide a significant pattern of overlap exceeding 50% of an intended coverage area, with the antenna patterns providing spatial diversity.

In a further aspect of the invention, a method for establishing an air interface in a shared channel communication system operating within a small space for wireless communication uses a sectorized antenna link for transmission and reception of a communication signal, and providing transmission and reception of RF signals in sectors. The sectors are apportioned such that at least two sectors have spatially separated antenna patterns. The spatial separation extends substantially along an intended coverage area while providing a significant pattern of overlap, and the antenna patterns of the antennas provide significant spatial diversity.

In accordance with the present invention, a base station for establishing an air interface in a shared channel communication system within a confined space for wireless communication includes a first antenna and at least one additional antenna. The first antenna has a first antenna pattern and communicates through an air interface through a first communication sector. The additional antenna has a second antenna pattern and communicates through an air interface in a second communication sector. The first and second sectors provide a significant pattern of overlap, and the antenna patterns provide significant spatial diversity.

In accordance with another aspect of the present invention, a base station for establishing an air interface in a shared channel communication system within a limited space for wireless communication includes a first RF communication circuit for establishing an air interface having a first antenna pattern, and at least one additional RF communication circuit establishing an air interface having a second antenna pattern. The first RF communication circuit and additional RF communication circuit establish a first communication sector and a second communication sector. The first and the second sectors provide a significant pattern of overlap exceeding 50% of an intended coverage area, and the antenna patterns provide spatial diversity.

In accordance with another aspect of the present invention, a method for establishing an air interface in a shared channel communication system operating within a small space for wireless communication includes establishing a sectorized antenna link for at least one of transmission and reception of a communication signal, providing transmission or reception of RF signals in sectors, and apportioning the sectors such that at least two sectors have spatially separated antenna patterns. The spatial separation extends substantially along an intended coverage area while providing a significant pattern of overlap, and antenna patterns of the antennas provide significant spatial diversity.

In accordance with another aspect of the present invention, a method for reducing signal transmission power of a shared channel communication system operating within a small space for wireless communication includes establishing a sectorized antenna link for transmission and reception of a communication signal, and providing transmission and reception of RF signals in sectors, and apportioning the sectors such that at least two sectors exhibit spatially diversity within an intended coverage area while providing a pattern of overlap exceeding 50% of the intended coverage area.

In accordance with another aspect of the present invention, a base station for establishing an air interface in a shared channel communication system within a small space for wireless communication includes means, including an antenna, for establishing a sectorized antenna link for a communication signal and providing communication of RF signals in sectors, and means for apportioning the sectors such that at least two sectors have spatially separated antenna patterns, in which the spatial separation extends substantially along an intended coverage area while providing a significant pattern of overlap. The antenna patterns provide significant spatial diversity.

### BRIEF DESCRIPTION OF THE DRAWINGS

The features, nature, and advantages of the present invention will become more apparent from the detailed description set forth below when taken in conjunction with the drawings in which like reference characters identify corresponding items throughout and wherein:

FIG. 1 is a diagram illustrating an example of a wireless communication network which includes a base station establishing a picocell.

FIG. 2 is a diagram of the wireless communication system of FIG. 1, in which a set of antennas provided an air interface exhibiting spatial diversity.

FIG. 3 is a diagram of the wireless communication system of FIG. 1 in which a set of antennas establishes sectors along the length of an aircraft.

FIG. 4 is a diagram showing the functional operation of a base station configured in accordance with the present invention.

FIG. 5 is a flow diagram depicting the functional operation of the invention.

FIG. 6 is a schematic block diagram showing the operation of a base station in accordance with the present invention.

### DETAILED DESCRIPTION OF THE INVENTION

The word “exemplary” is used herein to mean “serving as an example, instance, or illustration.” Any embodiment described herein as “exemplary” is not necessarily to be construed as preferred or advantageous over other embodiments.

### Overview

In certain wireless propagation environments, such as aircraft cabins, the goal of minimizing transmitted power on both the forward link and reverse link is more important than serving a large number of users in a spectrally efficient manner. In that environment, transmit power levels are more important than spectral efficiency because there are a limited number of WCDs and there is a requirement of minimizing the amount of RF energy transmitted due to potential susceptibility of airplane electrical systems. In an aircraft or a similar vehicle, signal propagation is greatly affected by the radio-reflective surface of the interior. The reflections have adverse effects on signal quality, but most WCDs are able to accommodate this. The signal reflections could therefore be ignored as far as ability to communicate with users is concerned, except that it is desired to limit the signal power of transmissions within the vehicle. According to the present invention, a technique that can be implemented for a wireless communication system is used to minimize the transmitted power levels for the terminal and the BTS.

According to the present invention, a microcell is configured to communicate in multiple sectors, with the sectors associated with spatially distributed antennas. Thus, according to one aspect of the invention, the multiple antennas associated with respective sectors exhibit a spatial diversity which is significant with respect to the coverage areas of the sectors. According to another aspect of the invention, the multiple sectors exhibit a significant coverage overlap, but with substantial spatial diversity of the antennas as compared with the coverage areas. According to another aspect of the invention, the antenna separation is a significant factor as compared to the coverage area of the communication sectors of a multiple sector communication station. The antennas are spatially distributed in order to provide multiple communication sectors, with the communication sectors implementing antenna patterns that ensure a large amount of overlap between the sector patterns for a substantial portion of the intended coverage area.

On the reverse link of a CDMA communication system, the signals received at spatially separated antennas can be cabled back to a BTS and coherently combined to result in significantly lower transmitted power requirements at the wireless communication device (WCD). Typically, the combining of the signals is achieved through a “softer handoff” between sectors. Since the propagation environment will often result in significantly different levels of fading between a given wireless communication device (WCD) and the spatially distributed sector antennas, the signal path between the WCD and at least one of the spatially distributed antennas is likely to be of high quality. Power control commands in a CDMA system would tell the WCD to decrease transmitted power in the reverse link until just enough power is being transmitted for successful communication at a reasonable error rate. The “active set” consists of sectors that have been chosen based on their utility to the reverse link demodulation process. On the forward link of IS95, CDMA2000, or WCDMA the signal from a BTS will be transmitted to a user from all sectors in the active set sectors that have been chosen based on their utility to the reverse link demodulation process, using sector specific spreading of the transmitted waveform. The WCD can then coherently combine the signal from each of the transmitting sectors using knowledge of the spreading codes, and since one of the sectors is likely to be received with a good signal quality, the amount of forward link power dedicated to the particular WCD will be decreased based on power control.

The overlapping sectors technique has limitations in terms of capacity of the base station; however in a typical aircraft environment, the number of WCDs is limited. This lowers the C/I on the forward link for the best serving sector since the interference component will include the signals from the other transmitting sectors. Since the overlapping of sectors causes more sectors to be seen by a user, this would limit the forward link data rate for systems such as 1×EV-DV and 1×EV-DO. The forward link capacity is restrained by dimensionality limit due to the finite (e.g 64 or 128) number of orthogonal Walsh codes. In the aircraft environment, it is anticipated that the number of users is small, and so accepting lower capacity is of little consequence. Instead, by the use of multiple sectors, it is possible to enable lower forward link and reverse link transmit power.

The lower transmit power has the effect of reducing noise caused by multiple users. Additionally, to the extent that active radiators are of concern in an aircraft, lowering the transmission power reduces the potential of interference with aircraft nav/comm. equipment.

### Operational Environment

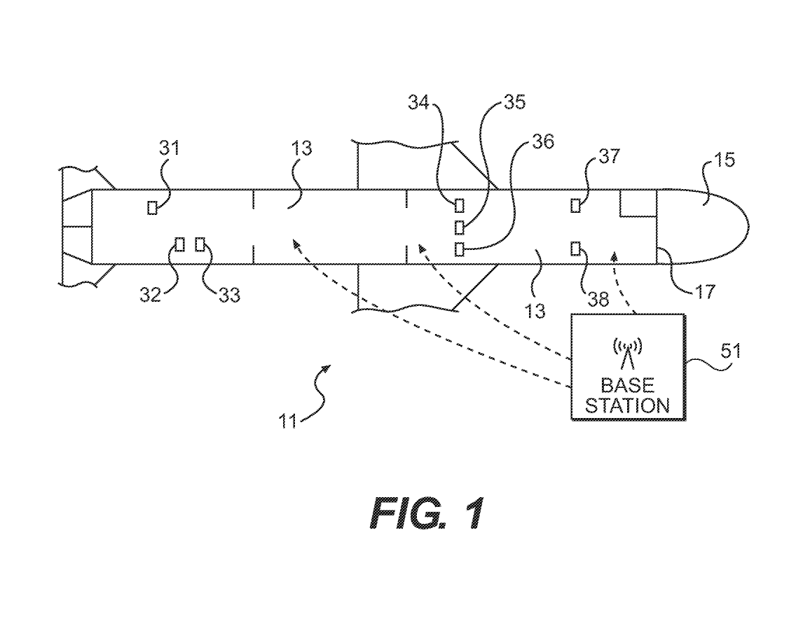

FIG. 1 is a diagram illustrating an example of a confined space, this example being a passenger transport aircraft 11. The aircraft 11 includes a passenger cabin 13, generally separated from the cockpit 15 by a forward bulkhead 17. The cockpit 15 is not of primary concern to the operation of the invention except that it is desired to reduce generation of RF power to which nav/comm and other avionics equipment in the cockpit 15 is exposed.

The passenger cabin 13 is in effect a long tube, which reflects RF transmissions generated within the cabin 13. The communications environment includes a number of users with wireless communication devices (WCDs) 31-38. This presents a unique environment for wireless communications in that transmissions include multiple reflected RF signal components, and the number of WCDs 31-38 is generally limited by the passenger capacity of the aircraft and the average number of WCDs used by each passenger. By way of example, a 100 passenger aircraft will have less than 100 wireless devices on primary (audio) channels and a corresponding number of devices on secondary channels. In addition to the forward bulkhead 17, additional bulkheads 41, 42 and other obstructions 43 are present in the aircraft. This presents a complex communication environment for a communication system whose parameters are established for optimum coverage of large terrestrial areas.

According to the present invention, a base station 51 establishing a picocell provides signals in multiple sectors, which are configured to enhance communication within a confined space. In the case of an aircraft cabin, the base station 51 is located on board the aircraft 11 and has its multiple sectors distributed in a manner such that at least two of the sectors is subject to a substantially different signal propagation path. In terms of the signal characteristics, this provides signal path diversity between sectors.

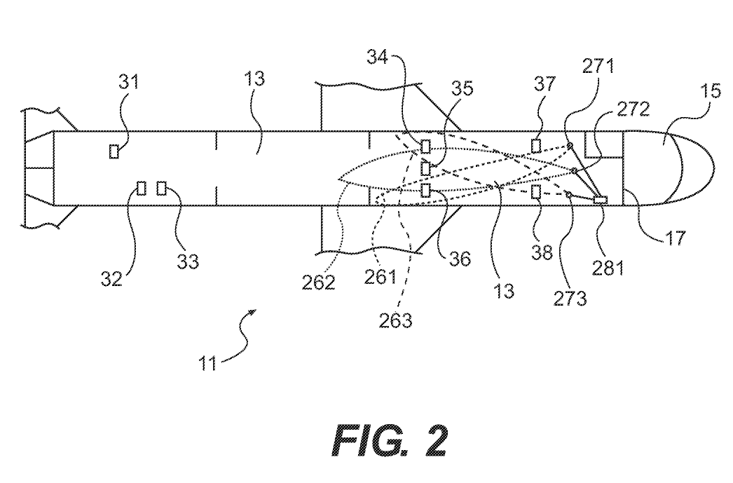

FIG. 2 is a depiction of the aircraft cabin 13, in which communication is effected from the area of bulkhead 17. According to one implementation, different sectors 261, 262, 263 are generated from a set of antennas which includes three antennas 271, 272, 273. The antennas 271-273 are connected with one base station establishing a picocell 281 in a manner that provides an air interface in the multiple sectors 261-263.

The representation shows a set of lobes; however the coverage of each lobe extends beyond the boundaries depicted in the diagram. The configuration is such that the antenna patterns of at least two of sectors provide spatial diversity of at least 1λ. The signal overlap is such that communication through the air interface can occur with any of the overlapping sectors in the area of overlap, and provide good quality of service (QoS).

The three antennas 271-273 provide communication through the respective sectors 261-263 and to that extent define the sectors 261-263. The sectors 261-263 are used for both transmit and receive and signals communicated in the sectors 261-263 have different sets of pseudorandom coding. Due to the reflective environment of the cabin 13, the coverage of the sectors 261-263 becomes much less defined than that depicted by the primary lobes.

Since sectors 261-263 are used as part of a common scheme of communication, it is possible for one WCD, for example WCD 33, to communicate in one of the sectors 261-263 and accept a communication handoff to another one of the sectors 261-263. Such a handoff can be a “soft handoff” or a “softer handoff”, in a manner common to inter-sector handoffs, or the handoff can be a “hard handoff”. While these different handoff types imply forward and reverse links, it is possible to provide sector communication in a single direction, such as a reverse link, without sectorizing the other link. It is possible for communication to be effected with a WCD in one sector in the forward link and in a different sector in the reverse link. By way of example, if the system has an inherent imbalance between forward and reverse links, the use of different sectors in the forward and reverse links may be convenient.

It is also possible to use a combination of sectorized and non-sectorized communication. The selection of sectors is generally a function of the WCD, so that the availability of overlapping sectors provides the WCD with the option of selecting from the multiple sectors. For example, in some types of systems it is common to transmit in one sector and receive in all sectors. There are also communications in which it is desired to communicate in one sector but not provide soft handoff and/or softer handoff. Similarly, it is possible to provide a system that uses one handoff scheme in a first type of communication and uses another handoff scheme in a different type of communication.

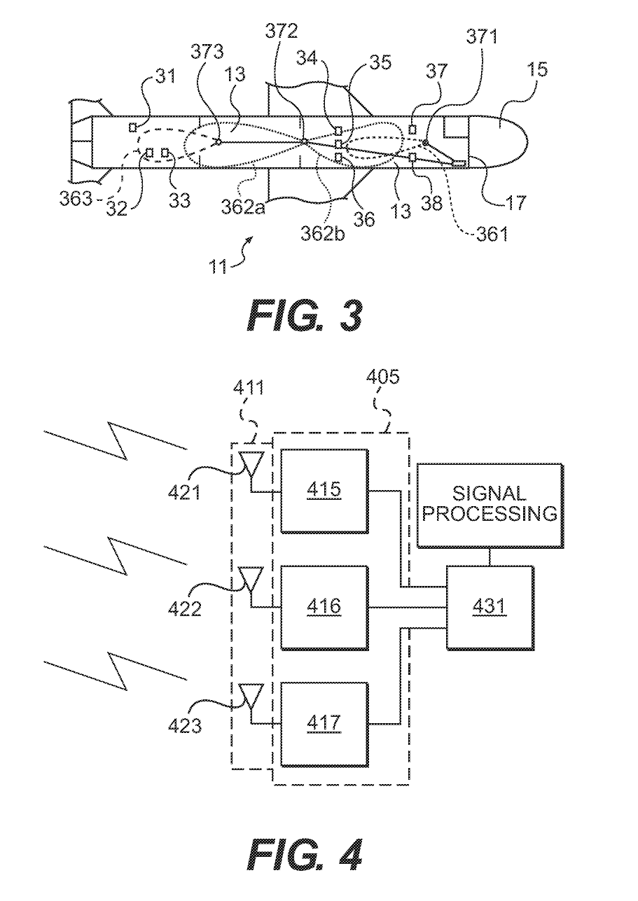

FIG. 3 is a configuration in which multiple sectors 361-363 are established by antennas 371-373 which are spaced along the length of the aircraft 11. The antennas 371-373 can be configured to provide directional signal lobes (sectors 361, 363) or can transmit multidirectionally or unidirectionally, as represented by sector 362 with primary signal lobes 362a and 362b. In this case signal lobes 362a and 362b are part of the same sector. The antennas 371-373 are connected with one base station establishing a picocell 381, in a manner that provides an air interface in the multiple sectors 361-363.

The arrangement of the antennas 371-373 for the different sectors 361-363 along the length of the cabin provides a substantial degree of spatial diversity, in which the antenna patterns sectors 371-373 provide spatial diversity of greater than 1λ. While it is desirable to provide communication with the different WCDs 31-38 through different sectors 361-363, predetermining the specific sector selected for a specific WCD is not important.

### Functional Operation

FIG. 4 is a diagram showing the functional operation of a base station for establishing a picocell 400 configured in accordance with the present invention. An RF interface module 405 provides means for establishing a sectorized antenna link for a communication signal and for providing communication of RF signals in sectors. A set of antennas 411 is connected to the RF interface module 405 to provide the desired sectors. The RF interface module 405 may be divided into separate RF circuits 415-417, each providing a signal connection through separate individual antennas 421-423.

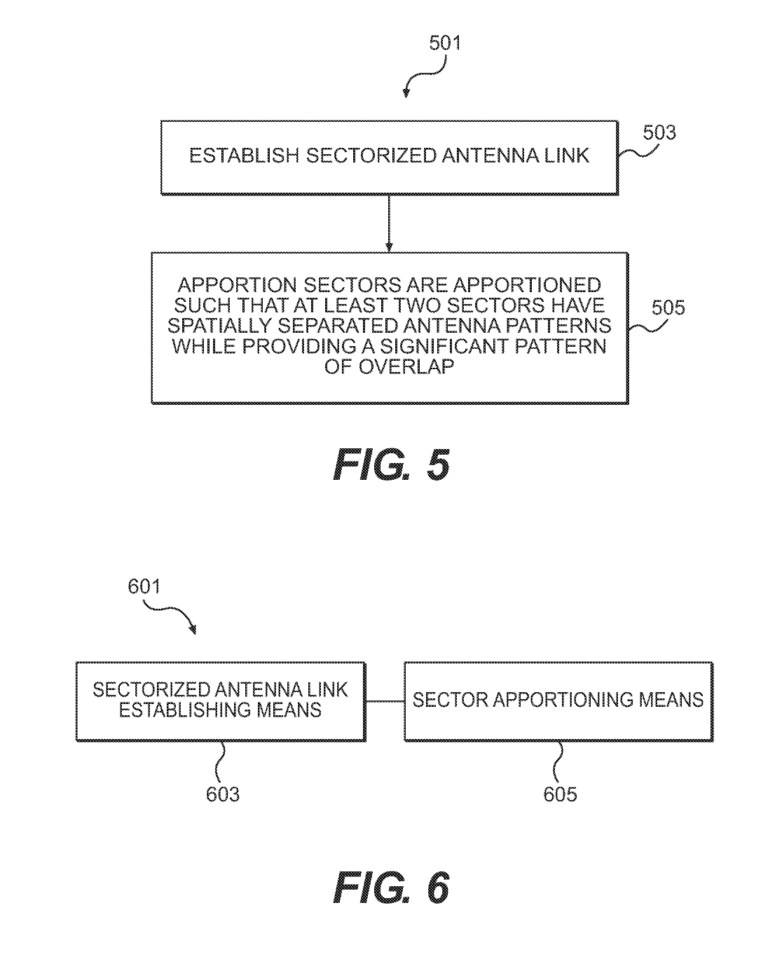

FIG. 5 is a flow diagram 501 depicting the functional operation of the invention. A sectorized antenna link is established (step 503) for transmission and reception of a communication signal, and providing transmission and reception of RF signals in sectors. The sectors are apportioned (step 505) such that at least two sectors have spatially separated antenna patterns, in which the spatial separation extends substantially along an intended coverage area while providing a significant pattern of overlap. This may be accomplished by physical separation, as a result of signal propagation or by a combination of the two. The antenna patterns of the antennas are configured to provide significant spatial diversity. The sectorized antenna link can be provided within a reflective enclosure, so that the spatially separated antennas permit communications at a reduced RF level as compared to communications provided from an antenna without spatial separation, while minimizing deadspots between sectors. This provides a technique for reducing signal transmission power of a shared channel communication system operating within a small space for wireless communication. The sectors can be configured to provide transmission and reception of RF signals in sectors and apportioned such that at least two sectors exhibit spatially diversity within an intended coverage area while providing a pattern of overlap exceeding 50% of the intended coverage area.

FIG. 6 is a schematic block diagram showing the operation of a base station for establishing a picocell 601 in accordance with the present invention. The base station for establishing a picocell 601 includes sectorized antenna link establishing means 603 which establishes links to WCDs in the sectors. Sector apportioning means 605 provide a diversity of signals in the sectors while providing overlap between the sectors. The result is a set of spatially diverse antenna patterns with a significant pattern of overlap.

Those skilled in the art will appreciate that the various illustrative logical blocks, modules, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, microprocessor, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a microprocessor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such the processor can read information from, and write information to, the storage medium. In the alternative, the storage medium may be integral to the processor. The processor and the storage medium may reside in an ASIC. The ASIC may reside in a user terminal.

In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein but is to be accorded the widest scope consistent with the principles and novel features disclosed herein.

What is claimed is:

1. A base station for establishing an air interface in a shared channel communication system within a confined space for wireless communication, the base station comprising:
a first antenna having a first antenna pattern and communicating through an air interface through a first communication sector;
at least one additional antenna having a second antenna pattern and communicating through an air interface in a second communication sector; wherein
the first and the second sector provide a significant pattern of overlap, and wherein the antenna patterns provide significant spatial diversity.

2. The base station of claim 1, wherein the significant pattern of overlap exceeds 50% of the coverage areas of the first and second antennas.

3. The base station of claim 1 wherein the antenna patterns of the first sector and the second sector provide spatial diversity of at least 1λ, and at least a 50% overlap of the first and second sectors.

4. The base station of claim 1 wherein:
the physical separation exceeds 1% of an intended coverage area for the base station corresponding to said small space; and
the antenna patterns of the first sector and the second sector provide spatial diversity of at least 1λ, and at least a 50% overlap of the first and second sectors.

5. The base station of claim 1 wherein:
the physical separation exceeds 5% of an intended coverage area for the base station corresponding to said small space; and
the antenna patterns of the first sector and the second sector provide spatial diversity of at least 1λ, and at least a 50% overlap of the first and second sectors.

6. The base station of claim 1 wherein:
the physical separation exceeds 10% of an intended coverage area for the base station corresponding to said small space; and
the antenna patterns of the first sector and the second sector provide spatial diversity of at least 1λ, and at least a 50% overlap of the first and second sectors.

7. The base station of claim 1 wherein said first antenna and said one additional antenna have a physical separation along a length of the small space, the physical separation providing the spatial diversity.

8. The base station of claim 1 wherein said first antenna and said one additional antenna have a physical separation along a width of the small space, and at least a 50% overlap of the first and second sectors, the physical separation providing the spatial diversity.

9. The base station of claim 1 comprising:
the antenna patterns of the first sector and the second sector providing at least 50% overlap; and
the antenna patterns providing spatial diversity of at least 1λ.

10. The base station of claim 1 comprising:
the antenna patterns of the first sector and the second sector providing at least 50% overlap; and
the antenna patterns providing spatial diversity of at least 1λ.

11. The base station of claim 1, comprising said sectors provided in an aircraft cabin, wherein the aircraft cabin establishes the confined space.

12. A base station for establishing an air interface in a shared channel communication system within a limited space for wireless communication, the base station comprising:
a first RF communication circuit for establishing an air interface having a first antenna pattern, thereby establishing a first communication sector;
at least one additional RF communication circuit establishing an air interface having a second antenna pattern, thereby establishing a second communication sector; wherein
the first and the second sector provide a significant pattern of overlap exceeding 50% of an intended coverage area, and wherein the antenna patterns provide spatial diversity.

13. The base station of claim 12 wherein the first and second communication sectors use different pseudorandom codes, and provide a soft or softer handoff between sectors for users communicating with the limited space.

14. The base station of claim 12, further comprising:
a circuit for establishing a sectorized antenna link for transmission and reception of a communication signal, and providing transmission and reception of RF signals in sectors; and
a circuit for apportioning the sectors such that at least two sectors have spatially separated antennas, in which the spatial separation extends substantially along an intended coverage area.

15. The base station of claim 12 wherein the antenna patterns of the first sector and the second sector provide spatial diversity of at least 1λ of the first and second sectors.

16. The base station of claim 12 wherein said first antenna and said one additional antenna have a physical separation along a length of the small space, the physical separation providing the spatial diversity.

17. The base station of claim 12 wherein said first antenna and said one additional antenna have a physical separation along a width of the small space while providing said at least a 50% overlap of the first and second sectors, the physical separation providing the spatial diversity.

18. A method for establishing an air interface in a shared channel communication system operating within a small space for wireless communication, the method comprising:
establishing a sectorized antenna link for at least one of transmission and reception of a communication signal, and providing said one of transmission or reception of RF signals in sectors; and
apportioning the sectors such that at least two sectors have spatially separated antenna patterns, in which the spatial separation extends substantially along an intended coverage area while providing a significant pattern of overlap, and wherein antenna patterns of the antennas provide significant spatial diversity.

19. The method of claim 18 comprising providing the sectorized antenna link within a reflective enclosure, whereby the spatially separated antennas permit communications at a reduced RF level as compared to communications provided from an antenna without spatial separation, while minimizing deadspots between sectors.

20. The method of claim 18 comprising using different pseudorandom codes for the first and second communication sectors, and providing a soft or softer handoff between sectors for users communicating with the small space.

21. The method of claim 18, further comprising:
establishing a sectorized antenna link for transmission and reception of a communication signal, and providing transmission and reception of RF signals in sectors; and
apportioning the sectors such that at least two sectors have spatially separated antennas, in which the spatial separation extends substantially along an intended coverage area.

22. The method of claim 18 comprising establishing antenna patterns of the first sector and the second sector provide spatial diversity of at least 1λ of the first and second sectors.

23. The method of claim 18 comprising providing a physical separation along a length of the small space between a first antenna and one additional antenna, the physical separation providing the spatial diversity.

24. The method of claim 18 wherein providing a physical separation along a width of the small space between a first antenna and one additional antenna while providing said at least a 50% overlap of the first and second sectors, the physical separation providing the spatial diversity.

25. The method of claim 18 comprising establishing the sectors in an aircraft cabin as the small space.

26. A method for reducing signal transmission power of a shared channel communication system operating within a confined space for wireless communication, the method comprising:
establishing a sectorized antenna link for transmission and reception of a communication signal, and providing transmission and reception of RF signals in sectors; and
apportioning the sectors such that at least two sectors exhibit spatially diversity within an intended coverage area while providing a pattern of overlap exceeding 50% of the intended coverage area.

27. The method of claim 26 comprising providing the sectorized antenna link within a reflective enclosure, whereby the spatially separated antennas permit communications at a reduced RF level as compared to communications provided from an antenna without spatial separation, while minimizing deadspots between sectors.

28. The method of claim 26 comprising using different pseudorandom codes for the first and second communication sectors, and providing a soft or softer handoff between sectors for users communicating with the confined space.

29. The method of claim 26, further comprising:
establishing a sectorized antenna link for transmission and reception of a communication signal, and providing transmission and reception of RF signals in sectors; and
apportioning the sectors such that at least two sectors have spatially separated antennas, in which the spatial separation extends substantially along an intended coverage area.

30. The method of claim 26 comprising establishing antenna patterns of the first sector and the second sector provide spatial diversity of at least 1λ of the first and second sectors.

31. The method of claim 26 comprising providing a physical separation along a length of the confined space between a first antenna and one additional antenna, the physical separation providing the spatial diversity.

32. The method of claim 26 wherein providing a physical separation along a width of the confined space between a first antenna and one additional antenna while providing said at least a 50% overlap of the first and second sectors, the physical separation providing the spatial diversity.

33. A base station for establishing an air interface in a shared channel communication system within a small space for wireless communication, the base station comprising:
means, including an antenna, for establishing a sectorized antenna link for a communication signal, said means providing communication of RF signals in sectors; and
means for apportioning the sectors such that at least two sectors have spatially separated antenna patterns, in which the spatial separation extends substantially along an intended coverage area while providing a significant pattern of overlap, and wherein antenna patterns provide significant spatial diversity.

34. The base station of claim 33, wherein the significant pattern of overlap exceeds 50% of the coverage areas of at least two sectors.

35. The base station of claim 1 wherein the means for establishing the sectorized antenna link uses different pseudorandom codes for each sector, and provides a soft or softer handoff between sectors for users communicating with the small space.

36. The base station of claim 33 wherein a plurality of distinct antennas provide the spatially separated antenna patterns.

37. The base station of claim 33 wherein:
a plurality of distinct antennas provide the spatially separated antenna patterns, such that at least two of the spatially separated antenna patterns provide at least 50% overlap in coverage areas; and
said two of the spatially separated antenna patterns provide spatial diversity of at least 1λ.

38. The base station of claim 33 wherein:
a plurality of distinct antennas provide the spatially separated antenna patterns by means of antenna directivity, such that at least two of the spatially separated antenna patterns provide at least 50% overlap in coverage areas; and
said two of the spatially separated antenna patterns provide spatial diversity of at least 1λ.

39. The base station of claim 33 wherein an active antenna system provides the spatially separated antenna patterns.

40. The base station of claim 33 comprising the means providing the sectorized antenna link provides spatial diversity within a reflective enclosure, whereby the apportioned sectors permit communications at a reduced RF level as compared to communications provided from an antenna without spatial separation, while minimizing deadspots between sectors.
